(19) United States
(12) Patent Application Publication
(10) Pub. No.: US 2011/0232981 A1
(43) Pub. Date: Sep. 29, 2011

(54) Movable grille shutter for vehicle

(75) Inventors: Kenji Hori, Anjo-shi (JP); Yoshimasa Asano, Kariya-shi (JP); Masumi Nishikawa, Toyoake-shi (JP)

(73) Assignee: Aisin Seiki Kabushiki Kaisha.

(21) Appl. No.: 13/064,375

(22) Filed: Mar. 22, 2011

(30) Foreign Application Priority Data
Mar. 25, 2010 (JP) 2010-070953

(51) Int. Cl. B60K 11/08

(52) U.S. Cl. 180/68.1

(57) ABSTRACT

A movable grille shutter for a vehicle includes a first fin adapted to be provided at a grille opening portion through which ambient air is taken in, a second fin adapted to be provided at the grille opening portion and be arranged so as to be parallel to the first fin, and an actuating device for actuating the first fin and the second fin so as to open or close the grille opening portion. The actuating device includes a first output shaft arranged on a rotational axis of the first fin, a second output shaft arranged on a rotational axis of the second fin so as to rotate in a direction opposite to a rotation of the first output shaft, a driving source for applying a driving force to the first output shaft and the second output shaft and an actuating device.

### CROSS REFERENCE TO RELATED APPLICATIONS

This application is based on and claims priority under 35 U.S.C. §119 to Japanese Patent Application 2010-070953, filed on Mar. 25, 2010, the entire content of which is incorporated herein by reference.

### TECHNICAL FIELD

This disclosure relates to a movable grille shutter for a vehicle, the grille shutter including a driving source and fins, the fins being provided at a grille opening portion of the vehicle and driven by the driving source.

### BACKGROUND DISCUSSION

According to a known movable grille shutter for a vehicle, in order to prevent poor combustion caused by an overcooled radiator within an engine room, a grille opening portion through which ambient air is taken in is operated to be opened or closed. For example, such grille shutter includes a plurality of fins provided at a base frame at a supporting shaft thereof so as to be freely rotatable in such a way that the fins are connected to each other by an interlocking arm, and the interlocking arm is connected to a link mechanism that is configured by a driving arm, formed so as to include a long through hole, and a pin arranged so as to be inserted into the long through hole. In this configuration, the driving arm is rotated by a driving source such as an actuator in order to operate the fins so as to open or close the grille opening portion (for example a movable grille shutter disclosed in JP58-139519U).

According to the known grille shutter disclosed in JP58-139519U, because the fins are rotated to open or close the grille opening portion in a manner where the fins follows a locus in the same direction, a distance between each of the supporting shaft of the fins is set to be wider. Further, in order to operate the fins by means of a single driving source, the fins need to be operated via a link mechanism and an area occupied by the operation such as a slide movement of the link mechanism may be wider. Furthermore, because the link mechanism has a complex structure, an efficiency of the force transmission may be lowered, accordingly the efficiency can not be easily estimated. In this configuration, an actuating device that may achieve a sufficient output needed for the sake of safety.

A need thus exists to provide a movable grille shutter for a vehicle, which is not susceptible to the drawback mentioned above.

### SUMMARY

According to an aspect of this disclosure, a movable grille shutter for a vehicle includes a first fin adapted to be provided at a grille opening portion through which ambient air is taken in, a second fin adapted to be provided at the grille opening portion and be arranged so as to be parallel to the first fin, and an actuating device for actuating the first fin and the second fin so as to open or close the grille opening portion, the actuating device including a first output shaft arranged on a rotational axis of the first fin, a second output shaft arranged on a rotational axis of the second fin so as to rotate in a direction opposite to a rotation of the first output shaft, and a driving source for applying a driving force to the first output shaft and the second output shaft.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side cross-sectional view of an engine room indicating an entire configuration of a grille shutter related to a first embodiment of this disclosure;

FIG. 2 is an exploded perspective view indicating an entire configuration of the grille shutter related to the embodiment of this disclosure; and

FIG. 3 is an explanation diagram for an inner configuration of an actuator related to the embodiment of this disclosure.

### DETAILED DESCRIPTION

An embodiment of this disclosure will be explained.

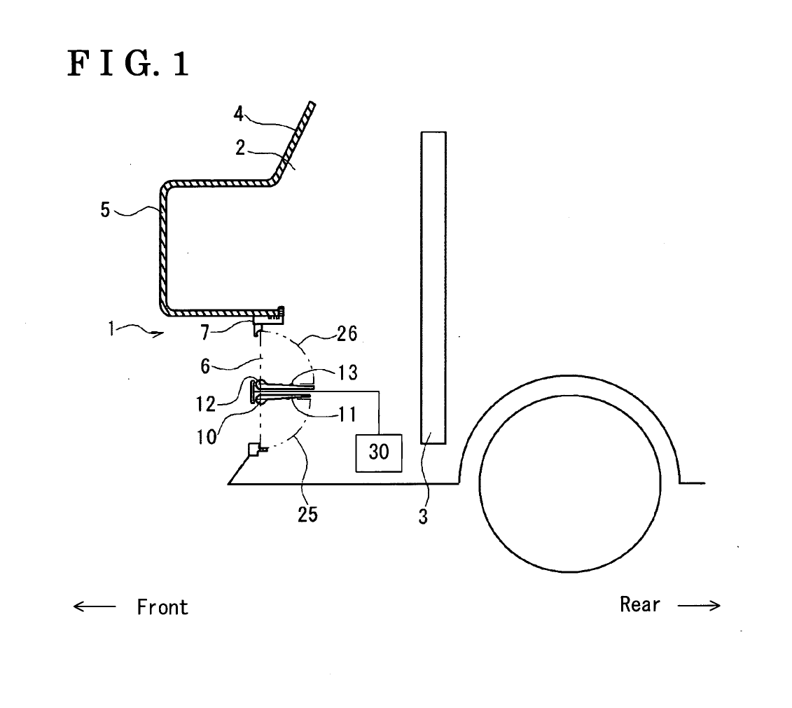

FIG. 1 is a side cross-sectional view of an engine room 2 indicating an entire configuration of a grille shutter 1 related to an embodiment of this disclosure. In the engine room 2, a radiator 3 for cooling an engine coolant is arranged so as to be attached to a vehicle body 4. At a lower front of the radiator 3 in a vehicle front-rear direction, a grille opening portion 6 is formed. At the grille opening portion 6, a base frame 7 is provided, and a first fin 11 is attached to the base frame 7 so as to be rotatable relative to a first rotational shaft 10 serving a rotational axis of the first fin 11, and a second fin 13 is attached to the base frame 7 so as to be rotatable relative to a second rotational shaft 12 provided in the vicinity of the first rotational shaft 10, the second rotational shaft 12 serving as a rotational axis of the second fin 13. The first fin 11 and the second fin 13 are operated so as to rotate symmetrically in a vertical direction of the vehicle.

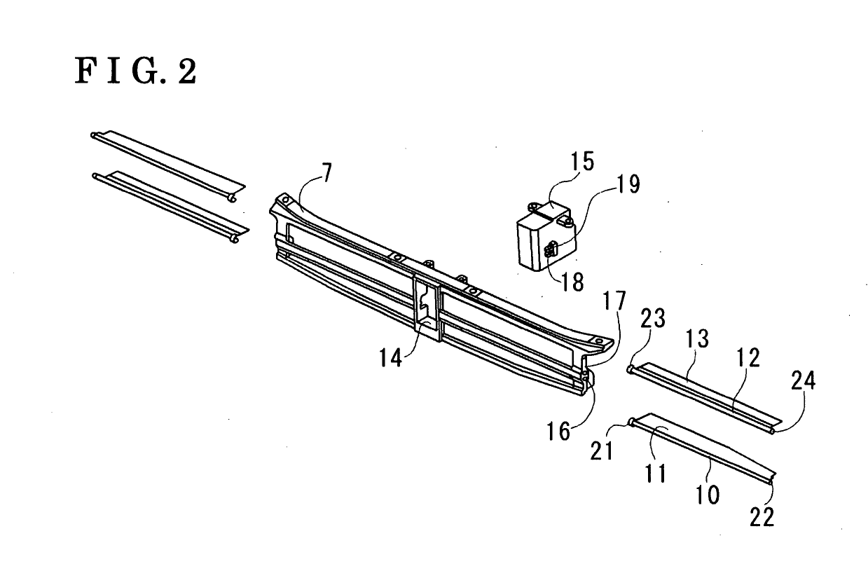

FIG. 2 is an exploded perspective view of an entire configuration of the grille shutter 1 related to the embodiment of this disclosure. As illustrated in FIG. 2, an actuator attaching portion 14 is provided at an intermediate portion of the base frame 7, and an actuator 15 (e.g., an actuating device) is attached to the base frame 7 at the actuator attaching portion 14 so as to be integral thereto. A first pair of the first and second fins 11 and 13 is provided at the right side of the base frame 7, and a second pair of the first and second fins 11 and 13 is also provided at the left side of the base frame 7. Because the first pair of the fins provided at the left side of the base frame 7 is provided in a similar manner as that of the second pair of fins provided at the right side of the base frame 7, an explanation of the configurations of the fins provided at the left side of the base frame 7 will be omitted, and only the configurations of the fins provided at the right side of the base frame 7 will be explained below. The base frame 7 is formed so as to include a first fin shaft supporting portion 16 and a second fin shaft supporting portion 17 at a right end portion of the base frame 7 in a width direction thereof. A first output shaft 18 and a second output shaft 19 are provided at the actuator 15. A first end portion 21 of the first fin 11 is connected to and supported by the first output shaft 18, and a second end portion 22 of the first fin 11 is supported by the first fin shaft supporting portion 16. In a similar manner, a first end portion 23 of the second fin 13 is connected to and supported by the second output shaft 19, and a second end portion 24 of the second fin 13 is supported by the second fin shaft supporting portion 17.

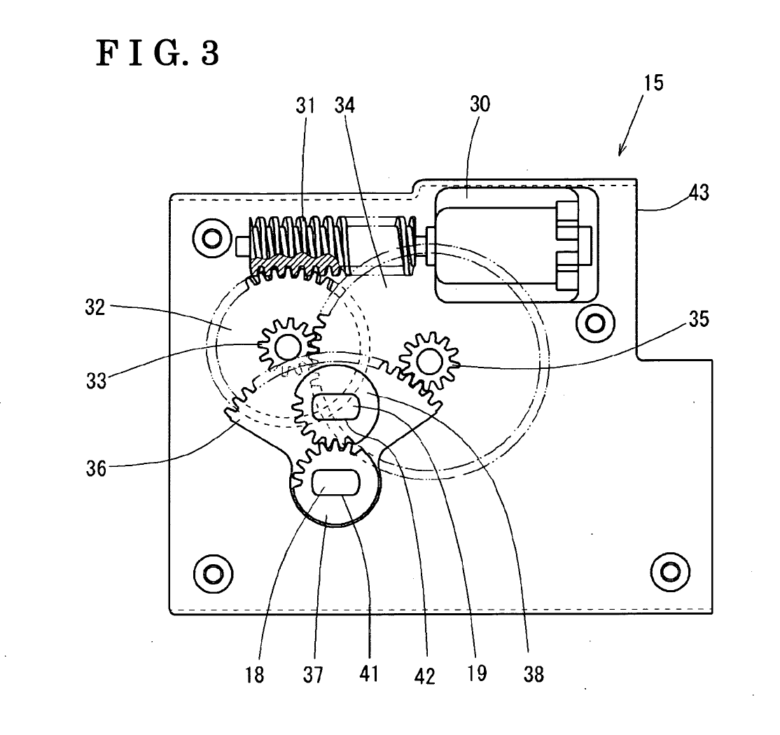

FIG. 3 is an explanation diagram for an inner configuration of the actuator 15 related to the embodiment of this disclosure. A worm gear 31 is provided at an output shaft of a motor 30 (e.g., a driving source), and the worm gear 31 is meshing with a worm wheel 32. The worm wheel 32 and a first pinion gear 33 are integrally and coaxially formed, and the first pinion gear 33 is meshing with the gear 34. The gear 34 is formed integrally and coaxially with a second pinion gear 35, and the second pinion gear 35 is meshing with a sector gear 36 being rotatable relative to the first output shaft 18. The sector gear 36 is formed so as to be coaxially and integrally with a first output gear 37 (e.g., a first gear), and the first output gear 37 is meshing with a second output gear 38 (e.g., a second gear) being rotatable relative to the second output shaft 19. On each of end surfaces of the first output gear 37 in an axial direction thereof, a first recessed portion 41, having two flat surfaces being parallel to each other, is formed. Further, a first protruding portion, having two flat surfaces being parallel to each other, is formed at the first end portion 21 of the first fin 11. In this configuration, the first fin 11 is supported by the actuator 15 in such a way that the protruding portion formed at the first end portion 21 of the first fin 11 is fitted to the first recessed portion 41 of the first output gear 37, so that the first fin 11 is integrally rotatable with the first output gear 37. Two of the second output gears 38 are provided in such a way that the worm wheel 32, the gear 34 and the sector gear 36 are sandwiched therebetween in the axial direction thereof, and a second recessed portion 42, having two flat surfaces being parallel to each other, is formed on a surface of each of the second output gear 38, and a second protruding portion, having two flat surfaces being parallel to each other, is formed at the first end portion 23 of the second fin 13. In this configuration, the second fin 13 is supported by the actuator 15 in such a way that the protruding portion formed at the first end portion 23 of the second fin 13 is fit to the second recessed portion 42 of the second output gear 38, so that the second fin 13 is integrally rotatable with the second output gear 38. The motor 30, the worm gear 31, the worm wheel 32, the first pinion gear 33, the gear 34, the second pinion gear 35, the sector gear 36, the first output gear 37 and the second output gear 38 are housed in the housing 43, thereby configuration the actuator 15.

A driving force generated at the motor 30 is transmitted to the first output gear 37 via the worm gear 31, the worm wheel 32, the first pinion gear 33, the gear 34, the second pinion gear 35 and the sector gear 36, thereby rotating the first output gear 37. The driving force transmitted to the sector gear 36 is further transmitted to the second output gear 38 via the first output gear 37, thereby rotating the second output gear 38 in a direction opposite to the rotation of the first output gear 37. Once the first and second output gears 37 and 38 are rotated, the first and second output shafts 18 and 19 are rotated, accordingly, the driving force generated at the motor 30 is eventually supplied to the first output shaft 18 and the second output shaft 19. Once the first and second output shafts 18 and 19 are rotated, the first fin 11 and the second fin 13 are operated in synchronization with each other so as to open or close the grille opening portion 6 in a manner where a top end of the first fin 11 follows a locus 25 (e.g., a first locus) that is symmetrical to a locus 26 (e.g., a second locus) determined by a top end of the second fin 13. When the first fin 11 and the second fin 13 are operated so as to fully open the grille opening portion, the first fin 11 is positioned so as to face the second fin 13.

According to the embodiment, the first output shaft 18 is arranged on the first rotational shaft 10 of the first fin 11, and the second output shaft 19 rotated in the direction opposite to the rotation of the first output shaft 18 is arrange at the second rotational shaft 12 of the second fin 13. Thus, the first fin 11 and the second fin 13 may be directly attached to the actuator 15, accordingly, compared to a case in which a link mechanism is used, an area in which the components are moved in accordance with an slide movement of the link mechanism does not need to be considered. Further, in this configuration, a level of mountability of the grille shutter may be increased. Further, because the link mechanism is not provided, a number of components may be reduced. Furthermore, because the driving force of the motor is transmitted to the fins by means of the gears, not using the link mechanism that may be formed in a complicated structure, an efficiency of the force transmission may be improved, accordingly the efficiency of the force transmission can be easily estimated. In this configuration, the motor 30 may be downsized by optimizing (e.g., minimizing) the output of the motor 30. Furthermore, the first fin 11, the second fin 13 and the actuator 15 may be combined so as to form an assembly, the assembly is attached to the base frame 7, thereby improving mountability to the vehicle.

According to the embodiment, because the first fin 11 and the second fin 13 are operated so as to rotate symmetrically in the vertical direction of the vehicle, the area defined by the locus 25 determined by the top end of the first fin 11 and the locus 26 determined by the top end of the second fin 13 may be reduced, and in a case where the first fin 11 and the second fin 13 are rotated so as to fully open the grille opening portion 6 and are arranged so as to face each other, an area occupied by the first fin 11 and the second fin 13 may be reduced, thereby the level of mountability may be increased. Further, because the first rotational shaft 10 may be arranged in the vicinity of the second rotational shaft 12, a level of processing accuracy of portions to which the shafts are attached may be increased, thereby improving the mountability.

According to the embodiment, because the first output shaft 18 is operated simultaneously with the second output shaft 19 in a structure where the first output gear 37 is meshing with the second output gear 38, the first fin 11 and the second fin 13 are firmly operated in synchronization with each other so as to open or close the grille opening portion 6.

According to the embodiment, because the driving force of the motor is transmitted to the second output gear 38 via the first output gear 37, the second output shaft 19 may be rotated in a direction that is opposite to the rotation of the first output shaft 18 without providing an idler gear or the like, accordingly the force transmitting path may be simplified.

According to the embodiment, the grille shutter 1 is configured by the two first fins 11 and the two second fins 13, and one of the first fins 11 and one of the second fins 13 are provided at the right of the actuator 15, and the other of the first fins 11 and the other of the second fins 13 are provided at the left of the actuator 15. In this structure, the width of each of the first fin 11 and the second fin 13 may be set so as to correspond to a width of the grille opening portion 6, and levels of distortions on the first fin 11 and the second fin 13 caused by a load of wind pressure applied thereto may be reduced, thereby firmly operating the first fins 11 and the second fins 13 so as to open or close the grille opening portion 6. Further, in this structure, the first fin 11 and the second fin 13 provided at the right of the actuator 15 and the first fin 11 and the second fin 13 provided at the left of the actuator 15 may be operated by means of a single component (the actuator 15).

According to the embodiment of this disclosure, an interlocking mechanism is provided at each of the first output shaft 18 and the second output shaft 19, however, the interlocking mechanism may be provided at each of the first rotational shaft 10 and the second rotational shaft 12. Further, the first rotational shaft 10 is arranged so as to be parallel to the second rotational shaft 12, however, the first rotational shaft 10 may be arranged so as to have an angle relative to the second rotational shaft 12 if there is a limitation related to mountability or a limitation related to an exterior design. A planetary gear mechanism may be used for the interlocking mechanism provided at each of the first output shaft 18 and the second output shaft 19, thereby arranging the first rotational shaft 10 so as to be coaxial with the second rotational shaft 12. A coaxial type speed reducing mechanism including a harmonic drive gear or a planetary gear train may be used as the speed reducing mechanism. In this configuration, the motor may be arranged coaxially with the first output shaft 18. The size of the first fin 11 provided at the right of the actuator 15 may be different from the size of the first fin 11 provided at the left of the actuator 15, and the size of the second fin 13 provided at the right of the actuator 15 may be different from the size of the second fin 13 provided at the left of the actuator 15. In a case where an entire width of the grille opening portion 6 is narrow, the actuator 15 may be positioned at a right end or a left end of the grille opening portion 6, and one first fin 11 and one second fin 13 may be provided.

According to the embodiment of this disclosure, the driving force from the motor 30 is transmitted to the second output gear 38 via the first output gear 37, and the driving force transmitted to the second output gear 38 is eventually supplied to the first and second output shafts 18 and 19, however, the driving force generated at the motor 30 may be directly transmitted to each of the first and second output shafts 18 and 19.

According to the embodiment of this disclosure, the movable grille shutter for the vehicle includes a first fin 11 adapted to be provided at a grille opening portion 6 through which ambient air is taken in, a second fin 13 adapted to be provided at the grille opening portion 6 and be arranged so as to be parallel to the first fin 11, a first output shaft 18 arranged on a rotational axis of the first fin 11, a second output shaft 19 arranged on a rotational axis of the second fin 13 so as to rotate in a direction opposite to a rotation of the first output shaft 18, a driving source 30 for supplying a driving force to the first output shaft 18 and the second output shaft 19 and an actuator 15 for actuating the first fin 11 and the second fin 13 so as to open or close the grille opening portion 6.

Thus, the first output shaft 18 is arranged on the first rotational shaft 10 of the first fin 11, and the second output shaft 19 rotated in the direction opposite to the rotation of the first output shaft 18 is arrange at the second rotational shaft 12 of the second fin 13. Thus, the first fin 11 and the second fin 13 may be directly attached to the actuator 15, accordingly, compared to a case in which a link mechanism is used, an area in which the components are moved in accordance with an slide movement of the link mechanism does not need to be considered. Further, in this configuration, a level of mountability of the grille shutter may be increased. Further, because the link mechanism is not provided, a number of components may be reduced. Furthermore, because the driving force of the motor is transmitted to the fins by means of the gears, not using the link mechanism that may be formed in a complicated structure, an efficiency of the force transmission may be improved, accordingly the efficiency of the force transmission can be easily estimated. In this configuration, the motor 30 may be downsized by optimizing (e.g., minimizing) the output of the motor 30. Furthermore, the first fin 11, the second fin 13 and the actuator 15 may be combined so as to form an assembly, the assembly is attached to the base frame 7, thereby improving mountability to the vehicle.

According to the embodiment of this disclosure, the first fin 11 and the second fin 13 are simultaneously moved in such a way that one end of the first fin 11 follows a first locus 25 and one end of the second fin 13 follows a second locus 26 that is symmetrical to the first locus 25, and when the first fin 11 and the second fin 13 are actuated so as to fully-open the grille opening portion 6, the first fin 11 and the second fin 13 are arranged in such a way that the first fin 11 faces the second fin 13.

According to the embodiment, because the first fin 11 and the second fin 13 are operated so as to rotate symmetrically in the vertical direction of the vehicle, the area defined by the locus 25 determined by the top end of the first fin 11 and the locus 26 determined by the top end of the second fin 13 may be reduced, and in a case where the first fin 11 and the second fin 13 are rotated so as to fully open the grille opening portion 6 and are arranged so as to face each other, an area occupied by the first fin 11 and the second fin 13 may be reduced, thereby the level of mountability may be increased. Further, because the first rotational shaft 10 may be arranged in the vicinity of the second rotational shaft 12, a level of processing accuracy of portions to which the shafts are attached may be increased, thereby improving the mountability.

According to the embodiment of this disclosure, the first output shaft 18 includes a first output gear 37, and the second output shaft 19 includes a second output gear 38 that is meshing with the first output gear 37.

According to the embodiment, because the first output shaft 18 is operated simultaneously with the second output shaft 19 in a structure where the first output gear 37 is meshing with the second output gear 38, the first fin 11 and the second fin 13 are firmly operated in synchronization with each other so as to open or close the grille opening portion 6.

According to the embodiment of this disclosure, the driving force from the motor 30 is transmitted to the first output shaft 18, and the driving force transmitted to the first output shaft 18 is further transmitted to the second output shaft 19.

According to the embodiment, because the driving force of the motor is transmitted to the second output gear 38 via the first output gear 37, the second output shaft 19 may be rotated in a direction that is opposite to the rotation of the first output shaft 18 without providing an idler gear or the like, accordingly the force transmitting path may be simplified.

According to the embodiment of this disclosure, the movable grille shutter further includes two of the first fins 11 and two of the second fins 13, wherein one of the first fins 11 is arranged on an axis of the first output shaft 18 on one side of the actuator 15 in an axial direction of the first output shaft 18, the other of the first fins 11 is arranged on the axis of the first output shaft 18 on the other side of the actuating device 15 in the axial direction of the first output shaft 18, one of the second fins 13 is arranged on an axis of the second output shaft 19 on one side of the actuating device 15 in an axial direction of the second output shaft 19, and the other of the second fins 13 is arranged on the axis of the second output shaft 19 on the other side of the actuating device 15 in the axial direction of the second output shaft 19.

According to the embodiment, the grille shutter 1 is configured by the two first fins 11 and the two second fins 13, and one of the first fins 11 and one of the second fins 13 are provided at the right of the actuator 15, and the other of the first fins 11 and the other of the second fins 13 are provided at the left of the actuator 15. In this structure, the width of each of the first fin 11 and the second fin 13 may be set so as to correspond to a width of the grille opening portion 6, and levels of distortions on the first fin 11 and the second fin 13 caused by a load of wind pressure applied thereto may be reduced, thereby firmly operating the first fins 11 and the second fins 13 so as to open or close the grille opening portion 6. Further, in this structure, the first fin 11 and the second fin 13 provided at the right of the actuator 15 and the first fin 11 and the second fin 13 provided at the left of the actuator 15 may be operated by means of a single component (the actuator 15).

According to the embodiment of this disclosure, a first recessed portion 41 having two flat surfaces being parallel to each other is formed at an end of the first output gear 37, a second recessed portion 42 having two flat surfaces being parallel to each other is formed at an end of the second output gear 38, a first protruding portion having two flat surfaces being parallel to each other is formed at an first end portion 21 of the first fin 11, and a second protruding portion having two flat surfaces being parallel to each other is formed at an second end portion 23 of the second fin 13, and wherein the first fin 11 is attached to the first output gear 37 so as to be integrally rotatably in a manner where the first recessed portion 41 is fitted to the first protruding portion, and the second fin 13 is attached to the second output gear 38 so as to be integrally rotatably in a manner where the second recessed portion 42 is fitted to the second protruding portion.

According to the embodiment of this disclosure, the grille opening portion 6 includes a first opening portion adapted to be opened or closed by the first fin 11 and a second opening portion adapted to be opened or closed by the second fin 13.

According to the embodiment of this disclosure, the first opening portion and the second opening portion are arranged in a vertical direction of the vehicle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A movable grille shutter for a vehicle comprising:
a first fin adapted to be provided at a grille opening portion through which ambient air is taken in;
a second fin adapted to be provided at the grille opening portion and be arranged so as to be parallel to the first fin; and
an actuating device for actuating the first fin and the second fin so as to open or close the grille opening portion, the actuating device including a first output shaft arranged on a rotational axis of the first fin, a second output shaft arranged on a rotational axis of the second fin so as to rotate in a direction opposite to a rotation of the first output shaft, and a driving source for applying a driving force to the first output shaft and the second output shaft.

2. The movable grille shutter for the vehicle according to claim 1, wherein the first fin and the second fin are simultaneously moved in such a way that one end of the first fin follows a first locus and one end of the second fin follows a second locus that is symmetrical to the first locus, and when the first fin and the second fin are actuated so as to fully-open the grille opening portion, the first fin and the second fin are arranged in such a way that the first fin faces the second fin.

3. The movable grille shutter for the vehicle according to claim 1, wherein the first output shaft includes a first gear, and the second output shaft includes a second gear that is meshing with the first gear.

4. The movable grille shutter for the vehicle according to claim 1, wherein the driving force from the driving source is transmitted to the first output shaft, and the driving force transmitted to the first output shaft is further transmitted to the second output shaft.

5. The movable grille shutter for the vehicle according to claim 1 including two of the first fins and two of the second fins, wherein one of the first fins is arranged on an axis of the first output shaft on one side of the actuating device in an axial direction of the first output shaft, the other of the first fins is arranged on the axis of the first output shaft on the other side of the actuating device in the axial direction of the first output shaft, one of the second fins is arranged on an axis of the second output shaft on one side of the actuating device in an axial direction of the second output shaft, and the other of the second fins is arranged on the axis of the second output shaft on the other side of the actuating device in the axial direction of the second output shaft.

6. The movable grille shutter for the vehicle according to claim 3, wherein a first recessed portion having two flat surfaces being parallel to each other is formed at an end of the first gear, a second recessed portion having two flat surfaces being parallel to each other is formed at an end of the second gear, a first protruding portion having two flat surfaces being parallel to each other is formed at an end portion of the first fin, and a second protruding portion having two flat surfaces being parallel to each other is formed at an end portion of the second fin, and wherein the first fin is attached to the first gear so as to be integrally rotatably in a manner where the first recessed portion is fitted to the first protruding portion, and the second fin is attached to the second gear so as to be integrally rotatably in a manner where the second recessed portion is fitted to the second protruding portion.

7. The movable grille shutter for the vehicle according to claim 1, wherein the grille opening portion includes a first opening portion adapted to be opened or closed by the first fin and a second opening portion adapted to be opened or closed by the second fin.

8. The movable grille shutter for the vehicle according to claim 7, wherein the first opening portion and the second opening portion are arranged in a vertical direction of the vehicle.
